(19) United States
(12) Patent Application Publication
(10) Pub. No.: US 2019/0177621 A1
(43) Pub. Date: Jun. 13, 2019

(54) HYDROCARBON RECYCLING OF CARBONIZER HOT GASES

(71) Applicant: AEMERGE LLC, Fortville, IN (US)

(72) Inventor: Landon C.G. MILLER, Fortville, IN (US)

(21) Appl. No.: 16/310,200

(22) PCT Filed: May 25, 2017
(86) PCT No.: PCT/US2017/034527

§ 371 Date: Dec. 14, 2018

Related U.S. Application Data
(60) Provisional application No. 62/350,097, filed on Jun. 14, 2016.

(51) Int. Cl. C10B 53/07; C10B 55/00; C10B 27/06; B01D 3/00; B01D 3/16; B01D 3/42; C10G 1/02

(52) U.S. Cl. CPC C10B 53/07; C10B 55/00; C10B 27/06; C10G 2300/1003; B01D 3/16; B01D 3/4211; C10G 1/02; B01D 3/007

(57) ABSTRACT

Systems and process are provided for refining off-gases that are produced by a carbonizer with a controlled heated column. The controlled heated column performs hydro-carbon recycling, and acts as a cracking tower that takes the carbonizer off-gas as a feedstock and distills the off-gases into constituent parts under pressure and temperature conditions where the feedstock evaporates and condenses into a fractional column of distillates. The carbonizer uses anaerobic thermal transformation processing to convert waste into bio-gas; bio-oil; carbonized materials; non-organic ash, distillates, and varied further co-products. The carbonaceous waste is transformed into useful co-products that are re-introduced into the stream of commerce at various economically advantageous points including carbon, carbon-based inks and dyes, activated carbon, aerogels, bio-coke, and bio-char, as well as generate electricity, produce adjuncts for natural gas, and/or various aromatic oils, phenols, and liquids, all depending upon the input materials and parameters

### CROSS-REFERENCE TO RELATED APPLICATION

This application claims priority of U.S. Provisional Patent Application Ser. No. 62/350,097 filed Jun. 14, 2016, which is incorporated herein by reference.

### FIELD OF THE INVENTION

The present invention in general relates to a system for transforming waste into useful co-products, including hydrocarbon based gases, hydrocarbon-based liquids, and carbonized material; and in particular, to a system for recycling and refining hot gases exiting from a carbonization system.

### BACKGROUND OF THE INVENTION

Pyrolysis is a general term used to describe the thermochemical decomposition of organic material at elevated temperatures without the participation of oxygen. Pyrolysis differs from other high-temperature processes like combustion and hydrolysis in that it usually does not involve oxidative reactions. Carbonization in these instances operates at less than 5 atomic % oxygen and typically less than 2 atomic % and is often characterized by irreversible simultaneous change of chemical composition and physical phase.

Pyrolysis is a case of thermolysis, and is most commonly used for organic materials, and is one of the processes involved in charring. Charring is a chemical process of incomplete combustion of certain solids when subjected to high heat. The resulting residue matter is called char. By the action of heat, charring reductively removes hydrogen and oxygen from the solid, so that the remaining char is composed primarily of carbon in a zero-oxidation state. Polymers such as thermoplastics and thermoset, as well as most solid organic compounds like wood and biological tissue, exhibit charring behavior when subjected to a pyrolysis process, which starts at 200-300° C. (390-570° F.) and goes above 1000° C. or 2150° F., and occurs for example, in fires where solid fuels are burning. In general, pyrolysis of organic substances produces gas and liquid products and leaves a solid residue richer in carbon content, commonly called char. Extreme pyrolysis, which leaves mostly carbon as the residue, is called carbonization.

The pyrolysis process is used heavily in the chemical industry, for example, to produce charcoal, activated carbon, methanol, and other chemicals from wood, to convert ethylene dichloride into vinyl chloride to make PVC, to produce coke from coal, to convert biomass into syngas and biochar, to turn municipal solid waste (MSW), and other carbonaceous matter into safely disposable substances, and for transforming medium-weight hydrocarbons from oil into lighter ones like gasoline. These specialized uses of pyrolysis are called by various names, such as dry distillation, destructive distillation, or cracking. Efficient industrial scale pyrolysis has proven to be difficult to perform and requires adjusting reactor conditions to feedstock variations in order to achieve a desired degree of carbonization.

Cracking is used to describe any type of splitting of molecules under the influence of heat, catalysts and solvents, such as in processes of destructive distillation or pyrolysis. Cracking is a high temperature and high pressure process whereby complex organic molecules such as kerogens or long chain hydrocarbons are broken down into simpler molecules such as light hydrocarbons, by the breaking of carbon-carbon bonds in the precursors. The rate of cracking and the end products are strongly dependent on the temperature and presence of catalysts. Cracking is also used to breakdown large alkanes into smaller, more useful alkanes and alkenes. A cracking tower is an apparatus for distilling a feedstock into constituent parts under high pressure and temperature where the feedstock evaporates and sorts itself by weight into a fractional column of distillates. The lightest fractions rise to the top of the tower where these lightest fractions condense at their molecular level and are drawn off as liquids. Medium weight fractions are taken from the middle region of the tower, and really heavy substances are tapped off at the bottom of the tower.

FIG. 1 is a functional block diagram distillation system 10 with a typical industrial cracking tower 12 used for fractional distillation. An example of use of fractional distillation is oil refineries to separate crude oil into useful substances or fractions having different hydrocarbons of different boiling points. The crude oil fractions with higher boiling points have more carbon atoms, have higher molecular weights, are less branched chain alkanes, are darker in color, are more viscous, and are more difficult to ignite and to burn. As shown in FIG. 1 reflux R is used to achieve a more complete separation of products obtained from feed 20 inputted to the tower 12. Reflux R refers to the portion of the condensed overhead liquid product from a distillation or fraction tower that is cooled with water in a condenser 18 that is returned to the upper part of the tower 12 from a reflux drum 14 with a pump 16, while the remaining useable overhead product 40 is yielded from the distillation system 10. Inside the cracking tower the reflux liquid flows downward (shown as arrows 36) and provides the cooling needed to condense the vapors flowing upward (shown as arrows 38), thereby increasing the effectiveness of the cracking towers distillation process. A reboiler 24 is fed bottoms liquids 34 that accumulate in the lower portion of the tower 12. The reboiler 24 heats the bottoms liquids 34 with supplied steam 26 with resultant vapor 30 inputted into the tower 12, while condensate 28 and bottoms product 32 are removed from the reboiler 24. The more reflux R that is provided for a given number of theoretical plates 22 in the tower 12, the more separation of lower boiling point from higher boiling materials is achieved in a given cracking tower 12. Alternatively, the more reflux R provided for a given desired separation, the fewer theoretical plates 22 that are required.

Cogeneration also referred to as combined heat and power (CHP) is the use of a heat engine or a power station to simultaneously generate both electricity and useful heat. All thermal power plants emit a certain amount of heat during electricity generation. The heat produced during electrical generation can be released into the natural environment through cooling towers, flue gas, or by other means. By contrast, CHP captures some or all of the by-product heat for heating purposes, or for steam production. The produced steam may be used for process heating, such as drying paper, evaporation, heat for chemical reactions or distillation. Steam at ordinary process heating conditions still has a considerable amount of enthalpy that could be also be used for power generation.

Transforming waste from a liability to an asset is a high global priority. Currently employed technologies rely on incineration to dispose of carbonaceous waste with useable quantities of heat being generated while requiring scrubbers and other pollution controls to limit gaseous and particulate pollutants from entering the environment. Incomplete combustion associated with conventional incinerators and the complexities of operation in compliance with regulatory requirements often mean that waste which would otherwise have value through processing is instead sent to a landfill or incinerated off-site at considerable expense. Alternatives to incineration have met with limited success owing to complexity of design and operation outweighing the value of the byproducts from waste streams.

To address this global concern, many methods have been suggested to meet the flexible needs of waste processing. Most of these methods require the use of a waste processing reactor, or heat source, which are designed to operate at relatively high temperature ranges 200-980° C. (400 to 2200° F.) and allow for continuous or batch processing.

“Chain Drag Carbonizer, System and Method for the Use thereof” as detailed in U.S. Pat. No. 8,801,904; the contents of which are hereby incorporated by reference, provides an apparatus and process for anaerobic thermal transformation processing to convert waste into bio-gas; bio-oil; carbonized materials; non-organic ash, and varied further co-products.

In the technology presented, any carbonaceous waste is transformed into useful co-products that can be re-introduced into the stream of commerce at various economically advantageous points. The carbonizer as disclosed has utility to support a variety of processes, including to make, without limitation, carbon, carbon-based inks and dyes, activated carbon, aerogels, bio-coke, and bio-char, as well as generate electricity, produce adjuncts for natural gas, and/or various aromatic oils, phenols, and other liquids, all depending upon the input materials and the parameters selected to process the waste, including real time economic and other market parameters which can result in the automatic re-configuration of the system to adjust its output co-products to reflect changing market conditions.

“Infectious Waste Disposal” as detailed in Patent Cooperation Treaty Application PCT/US16/13067; the contents of which are hereby incorporated by reference provides a medical waste handling and shredding sub-system with a built-in oxidizer to eliminate potential airborne infectious waste prior to transforming the medical waste into useful co-products, including hydrocarbon based gases, hydrocarbon-based liquids, precious metals, rare earths (vaporization temperatures range from about 1200° C. to about 3500° C.), and carbonized material in a system having as its transformative element an anaerobic, negative pressure, or carbonization system. The system includes a sealed enclosure that houses a shredder that is fed by a vertical lift and/or a belt conveyor that supplies the infectious waste running from the exterior of the sealed enclosure to the shredder. The shredder further includes a hopper to receive waste and a process airlock where shredded wasted material accumulates and is transferred to the feed conveyor. A rubberized exterior flap permits containerized and bagged waste to enter the sealed enclosure via the belt conveyor. The sealed enclosure may be maintained at a negative pressure. A thermal oxidizer in fluid communication with the sealed enclosure and a hood acts to destroy any airborne infectious matter from the sealed enclosure and any airborne infectious waste collected by the hood. The thermal oxidizer may be run on a mixture of natural gas and reaction-produced carbonization process gases re-circulated to transform heat through the use of either conventional steam boilers or through Organic Rankin Cycle strategies to operate electrical turbine generators, or in the alternative, to conventional or novel reciprocating engine driven generators. A feed conveyor transfers shredded material from the shredder to a carbonizer.

While there have been many advances in recovering useable byproducts from recycled waste there continues to be a need for further limiting emissions from the recycling and recovery process that further maximizes recovered byproducts. Thus, there exists a need for a process of waste reaction that is efficient to operate to limit environmental pollution in the course of such a transformation, and to produce useful co-products that aid on the overall economic value of the process.

### SUMMARY OF THE INVENTION

A system for treating waste is provided that includes a controlled heated column with a series of temperature zones, a carbonizer in fluid communication with the controlled heated column, where the carbonizer anaerobically thermally converts the waste and resultant hot gases produced from the carbonizer and are supplied to the controlled heated column, and one or more outputs that correspond to the series of temperature zones that supply distillates obtained from the supplied hot gases.

A method of using the system for refining the hot gases that are produced by a carbonizer includes adjusting a set of parameters of the carbonizer based on waste feed stock to be inputted, setting processing parameters for the controlled heated column based on anticipated distillates to be obtained from the hot gases supplied by the carbonizer, loading waste feedstock into the carbonizer, obtaining useable co-products and byproducts from the carbonizer, supplying hot gases from the carbonizer to the controlled heated column, and collecting usable distillates from the one or more outputs that correspond to the series of temperature zones of the controlled heated column.

### BRIEF DESCRIPTION OF THE DRAWINGS

The present invention is further detailed with respect to the following drawings. These figures are not intended to limit the scope of the present invention but rather illustrate certain attributes thereof.

FIG. 1 is a prior art functional block diagram of a typical industrial distillation tower;

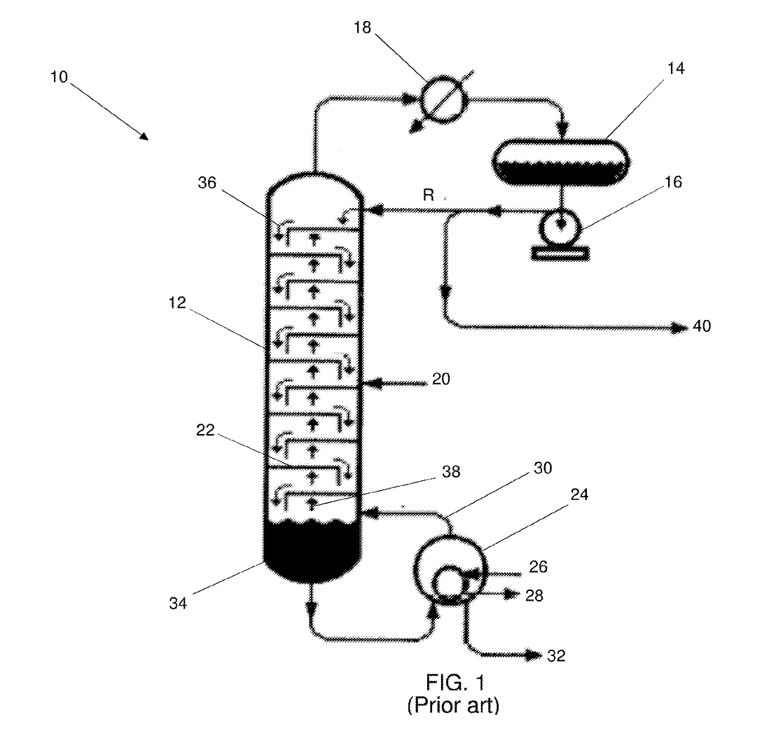

FIG. 2 is a block diagram of a carbonizer with a controlled heated column for refining and recovery of carbonizer hot gases in accordance with embodiments of the invention;

FIG. 3 is a flowchart of a process for refining off-gases that are produced by a carbonizer in accordance with embodiments of the invention; and

FIG. 4 is a functional block diagram of a furnace to heat a feedstock prior to entry into a controlled heated column for refining and recovery of useable products in accordance with embodiments of the invention.

### DESCRIPTION OF THE INVENTION

An inventive system and method for refining off-gases that are produced by a carbonizer is provided with a controlled heated column for refining and recovery of the carbonizer hot gases. The controlled heated column performs hydro-carbon recycling, and acts as a cracking tower that takes the carbonizer off-gas as a feedstock and distills the off-gases into constituent parts under pressure and temperature conditions where the feedstock evaporates and condenses into a fractional column of distillates. The number of theoretical plates needed to exact a desired level of separation is readily calculated using the Fenske equation. The carbonizer may use anaerobic thermal transformation processing to convert waste into bio-gas; bio-oil; carbonized materials; non-organic ash, and varied further co-products. In the inventive technology presented herein, any carbonaceous waste is transformed into useful co-products that can be re-introduced into the stream of commerce at various economically advantageous points. The present invention has utility to support a variety of processes, including to make, without limitation, carbon, carbon-based inks and dyes, activated carbon, aerogels, bio-coke, and bio-char, as well as generate electricity, produce adjuncts for natural gas, and/or various aromatic oils, phenols, and other liquids, all depending upon the input materials and the parameters selected to process the waste, including real time economic and other market parameters which can result in the automatic re-configuration of the system to adjust its output co-products to reflect changing market conditions. Distillates extracted are appreciated to be a function of the chemical nature of the feedstock and the carbonizer conditions. Illustrative distillates include C2-C36 compounds of alkanes, alkenes, ethers, esters, phenols, aromatics, lignins, polycyclics; and substituted versions thereof where the substituent in place of a hydrogen atom is for example, a hydroxyl, an amine, a sulfonyl, a carboxyl, a halogen, or a combination thereof.

As used herein, the terms “carbonized material”, “carbonaceous product” and “carbonaceous material” are used interchangeably to define solid substances at standard temperature and pressure that are predominantly inorganic carbon by weight and illustratively include char, bio-coke, carbon, activated carbon, aerogels, fullerenes, and combinations thereof.

It is appreciated that a feedstock is readily treated with a variety of solutions or suspensions prior to carbonizer to modify the properties of the resulting inorganic carbon product. By way of example, solutions or suspensions of metal oxides or metal salts are applied to a feedstock to create an inorganic carbon product containing metal or metal ion containing domains. Metals commonly used to dope an inorganic carbon product illustratively include iron, cobalt, platinum, titanium, zinc, silver, and combinations of any of the aforementioned metals.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Since a core element of the inventive process for refining off-gases that are produced by a carbonizer is carbonization, there are a wide variety of possible operating configurations and parameters to adjust product mixes and waste stream throughput. The system is readily re-configured, and system operating parameters changed, some in real time, to adjust co-product outputs and percentages thereof to reflect on-going market conditions. For illustrative purposes, wood, before entering the process, can have its moisture removed, but not so much as to “burst” the plant cells within the cellular structure of the wood, but rather to rendered contained water as steam and thus destroy the cellular fabric of the wood. The temperature range, duration of exposure, mixing rate, and other factors claimed as part of the inventive process, machine and system of systems herein are thus focused on controlling the many variables inherent in such anaerobic thermal transformation processes in order to produce results with utility for future use as opposed to just destruction.

System configuration in certain embodiments includes carbonization process heat source generators that run on a mixture of natural gas or electrical heat and reaction-produced carbonization process gases, if present, re-circulated to operate the drag chain reactor and thereby generate the heat needed to operate the carbonization process. This heat capture in turn produces more waste heat that is used to heat water and generate steam for turbines or steam reciprocating engines or subsequent distillation processes. This heat in some inventive embodiments is then also used to preheat feedstock or to produce electricity. The pre-processing heating system preheats feedstock material prior to entering the reactor tube.

A carbonization system in specific inventive embodiments also utilizes a thermo-chemical reactor which may be a drag-chain reactor, or others such as, but not limited to batch, continuous-stirred-tank, thermal oxidizers, or plug-in reactors.

Another important element of an inventive system is the use of an air-seal, which not only aids mixing and heat diffusion, but allows pressurization of, or the creation of a partial or complete vacuum within the reactor for various reasons, including preventing gaseous contaminants from escaping the reactor, managing pressures, and managing the flow of gases within the overall reactor and associated processing elements.

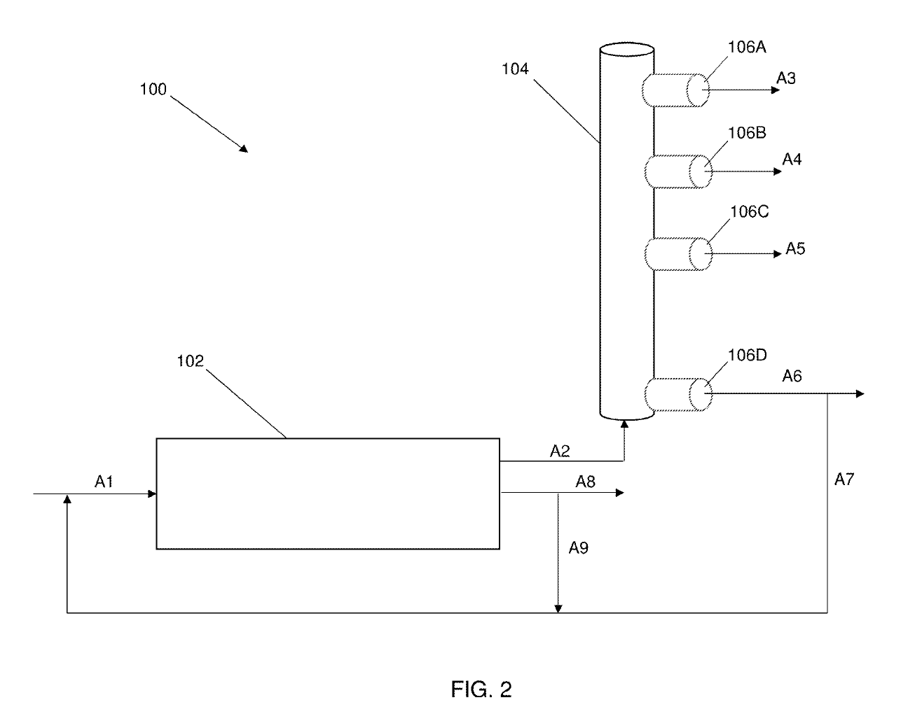

Referring now to the figures, FIG. 2 is a block diagram of a system 100 with a carbonizer 102 with a controlled heated column 104 for refining and recovery of by-products from carbonizer hot gases. The carbonizer 102 may perform anaerobic thermal transformation processing that converts input (arrow A1) illustratively including, but not limited to municipal solid waste, infectious medical waste, and bitumen into useable products (arrow A8) such as bio-gas; bio-oil; carbonized materials; non-organic ash. Non-useable output (arrow A9) from the carbonizer 102 may either be safely disposed of, or recirculated back into the carbonizer 102 for further processing. A non-limiting example of a carbonizer operative with a controlled heated column 104 for refining and recovery of by-products from carbonizer hot gases is detailed in U.S. Pat. No. 8,801,904; the contents of which are incorporated herein by reference. Hot gases (arrow A2) generated by and in the carbonizer 102 are feed to the controlled heated column(s) 104 for hydro-carbon re-cycling (cracking). Temperature cut points (zones) within the controlled heated column 104 are signified by outputs 106A-106D that supply distillates represented by arrows A3, A4, and A5. Remaining hot gases or solids (arrow A6) that do not distill out as a useable by-product may either be further scrubbed and safely disposed of, or recirculated (arrow A7) into the carbonizer 102 for further processing.

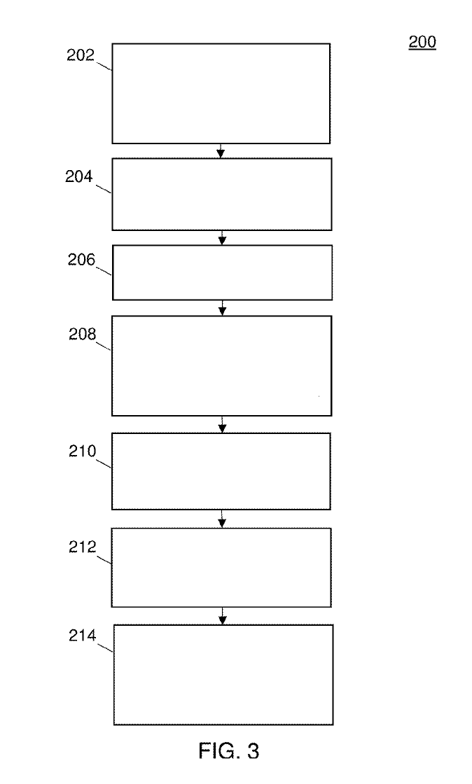

FIG. 3 is a flowchart of a process 200 for refining off-gases that are produced by a carbonizer. The process 200 starts by adjusting the parameters of the carbonizer based on waste feed stock to be inputted (Step 202). Carbonizer parameters may illustratively include temperature, conveyor speed, dwell times, and atmosphere. Based on the inputted feedstock, processing parameters are set for the controlled heated column based on anticipated distillates to be obtained from the off-gas of the carbonizer (Step 204). For example, temperature zones may be set based on the anticipated distillates. In some inventive embodiments, once the carbonizer is at the required temperature, waste feedstock is loaded into the carbonizer (Step 206). Subsequently, useable byproducts obtained from the carbonizer are collected, and non-useable outputs are either safely disposed of or reintroduced into the carbonizer (Step 208). Hot gases that result from the carbonizer are supplied to the controlled heated column for hydrocarbon recycling (Step 210). It is appreciated that in some inventive embodiments, a conventional cracking catalyst is provided to promote bond scission in byproducts to promote formation of volatile by products. Organometallics and metals are exemplary of conventional cracking catalysts. Usable distillates are collected from temperature cut points (zones) (Step 212) and non-useable output from the controlled heated column is either collected as a sludge or reintroduced into the carbonizer (Step 214).

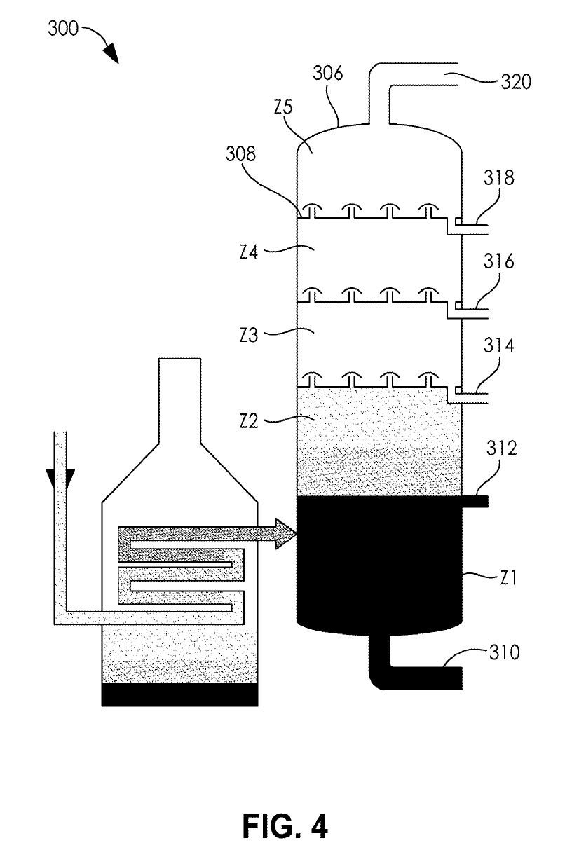

FIG. 4 is a functional block diagram of a system 300 with a furnace 302 to heat a feed stock in feed tubing 304 prior to entry into a controlled heated column 306 for refining and recovery of useable products. In the example shown in FIG. 4 the heated column 306 is divided into five temperature cut points or zones (Z1-Z5) that are divided with vented plates 308. It is appreciated that any number of cut points or zones may be introduced into the heated column 306 for a finer distribution of products. The zones (Z1-Z5) of the heated column have a series of outlets (310-320) that yield recovered products from the feedstock that is distilled in the heated column 306.

### EXAMPLES

### Example 1

In conjunction with FIG. 4, crude oil is feed via feed tubing 304 into furnace 302 to heat to a temperature of approximately 504° C. (940° F.) prior to entry into the controlled heated column 306 for refining and recovery of useable petroleum based products. The heated column 306 is divided into five heated zones as follows: Z1 is set at 400° C. (752° F.), Z2 is set at 370° C. (701.6° F.), Z3 is set at 300° C. (572° F.), Z4 is set at 200° C. (392° F.), and Z5 is set at 150° C. (701.6° F.). Lubricating oil, paraffin wax, asphalt drops out of the bottom outlet 310 from zone Z1 of the column 306. Fuel oil is yielded from outlet 312 of zone Z2. Diesel oil is yielded from outlet 314 from zone Z3 of the column 306. Kerosene is yielded from outlet 316 from zone Z4 of the column 306. Gasoline is yielded from outlet 318 from zone Z5 of the column 306. Gas rises from zone Z5 and is water cooled to 20° C. (68° F.).

As a person skilled in the art will recognize from the previous detailed description and from the figures and claims, modifications and changes can be made to the preferred embodiments of the invention without departing from the scope of this invention defined in the following claims.

1. A system for treating waste, the system comprising:
a controlled heated column with a series of temperature zones;
a carbonizer in fluid communication with said controlled heated column, where said carbonizer anaerobically thermally converts the waste and resultant hot gases produced from said carbonizer and are supplied to said controlled heated column; and
one or more outputs that correspond to the series of temperature zones that supply distillates obtained from the supplied hot gases.

2. The system of claim 1 wherein the waste feed stock includes at least one of municipal solid waste, infectious medical waste, or bitumen that optionally contains non-reactive inorganics.

3. The system of claim 1 wherein said carbonizer employs anaerobic thermal transformation processing to treat the waste feed stock.

4. The system of claim 1 wherein said carbonizer utilizes a thermo-chemical reactor, where said thermos-chemical reactor is one of a drag-chain reactor, batch reactor, continuous-stirred-tank reactor, rotating drum, thermal oxidizers, or plug-in reactor.

5. The system of claim 1 wherein said carbonizer has a partial or complete vacuum.

6. A method of using the system of claim 1 for refining the hot gases that are produced by said carbonizer, the method comprising:
adjusting a set of parameters of said carbonizer based on waste feed stock to be inputted;
setting processing parameters for said controlled heated column based on anticipated distillates to be obtained from the hot gases supplied by the carbonizer;
loading waste feedstock into said carbonizer;
obtaining useable co-products and byproducts from said carbonizer;
supplying hot gases from said carbonizer to said controlled heated column; and
collecting usable distillates from the one or more outputs that correspond to the series of temperature zones of said controlled heated column.

7. The method of claim 6 further comprising disposing any non-useable output from said controlled heated column, or reintroducing the non-useable output into said carbonizer.

8. The method of claim 6 wherein the adjustable set of parameters for said carbonizer comprise one or more of temperature, conveyor speed, dwell times, and atmosphere.

9. The method of claim 6 wherein a processing parameter of said controlled heated column includes setting temperature zones.

10. The method of claim 6 wherein the waste feed stock includes at least one of municipal solid waste, infectious medical waste, or bitumen that optionally contains non-reactive inorganics.

11. The method of claim 6 wherein said carbonizer employs anaerobic thermal transformation processing to treat the waste feed stock.

12. The method of claim 6 wherein said carbonizer utilizes a thermo-chemical reactor, where said thermos-chemical reactor is one of a drag-chain reactor, batch reactor, continuous-stirred-tank reactor, rotating drum, thermal oxidizers, or plug-in reactor.

13. The method of claim 6 wherein said carbonizer has a partial or complete vacuum.
